(19) United States
(12) Patent Application Publication
(10) Pub. No.: US 2018/0322573 A1
(43) Pub. Date: Nov. 8, 2018

(54) SYSTEMS AND METHODS FOR IMPLEMETING A META-QUEUE FOR TRANSACTIONS

(71) Applicant: IEX GROUP, INC., New York, NY (US)

(72) Inventors: Adrian Facini, Brooklyn, NY (US); Francis Chung, New York, NY (US); Daniel Aisen, New York, NY (US); Robert Park, New York, NY (US); Bradley Katsuyama, New York, NY (US); Constantine Sokoloff, Jersey City, NJ (US)

(21) Appl. No.: 15/589,406

(22) Filed: May 8, 2017

(51) Int. Cl. G06Q 40/04

(52) U.S. Cl. CPC G06Q 40/04; G06Q 30/0283

(57) ABSTRACT

In a system for processing transactions, a received request for a transaction is either placed in a meta-queue or placed in a priority-parameter-based queue, depending on whether the request was received while the meta-queue was open. The transaction requests placed in the priority-parameter-based queue are processed only after all requests in the meta-queue are completely processed, and the requests in the priority-parameter-based queue are generally processed in the order of time of arrival of the requests. The requests in the meta-queue are not prioritized solely on the basis of the time of arrival, and may be selected for processing based on one or more request parameters, which can include the time of arrival. A selected portion of several or all requests in the meta-queue may be processed before processing another portion of one or more requests.

### FIELD OF THE INVENTION

This disclosure generally relates to systems and methods for receiving and processing data and transaction requests and, in particular, to managing priorities of at least some of the transaction requests.

### BACKGROUND OF THE INVENTION

A typical electronic trading venue receives from several participants requests for transactions in items for interest. Examples of such requests include requests for trading stocks, bids on an article in an auction, requests for trading tickets to sports events, etc. The orders may be divided into different classes according to parameters such as a trading price specified in the order, order volume (e.g., the number of shares in a stock-trading order), designated status of the participant trader, etc. In addition to dividing of the orders into classes, or alternatively, the transaction orders are usually prioritized in the order in which they were received. In other words, the orders may be prioritized according to the time at which they were received regardless of the class to which the orders belong, or the time-of-arrival-based prioritization may be performed within each class. Generally, an order received earlier than other orders is processed before processing the other orders.

While the above-described prioritization policy, which generally gives preference to a venue participant taking actions before other participants, can be fair in various situations, in some cases some participants can exploit technology to receive an undue benefit. Specifically, some participants (referred to as high-speed participants for the sake of convenience) have access to extremely high speed specialized communication and/or computing resources, using which they can routinely access information relevant to an order and/or may generate such an order slightly before many other participants. Additionally or in the alternative the high-speed participants may be physically located closer to sources of information relative to others, which allows the high-speed participants to access relevant information slightly before others.

Taking advantage of access to specialized communication and/or computation technology and/or physical location, some high-speed participants can then transmit their transaction orders slightly before the other participants, and these orders may be received slightly before the orders submitted by other participants. In some cases, the high-speed participants may be physically located closer to the venue relative to other participants and, as such, even if they submit an order at the same time as another participant, the order submitted by the high-speed participant would be received slightly before the orders submitted by the other participant. In this context, slightly before generally means a few or several microseconds, a few or several milliseconds, or a few seconds before. The high-speed participants' orders, received only slightly before the orders of other participants, may be regularly prioritized over the orders of the other traders when the time of arrival is mainly or exclusively used for order prioritization.

Having access to specialized communication and/or computing technology and/or choosing a particular physical location are not necessarily unfair to others. Nevertheless, in some cases the other participants, who were only slightly late, may suffer harm such as losing a bid to buy or an opportunity to sell an item of interest, paying more than others for a purchased item, and/or receiving less than others for a sold item, etc. This can discourage some venue participants who do not have access to specialized very high speed communication and/or computing technology.

### SUMMARY OF THE INVENTION

Various embodiments described herein allow a transactions venue to prevent one or more participants whose transaction orders are received only slightly before other orders from always receiving the highest priority. As such, other participants, whose orders are received only slightly after one or more of the earliest received orders may be processed, at least in part, before one or more of the earliest received orders are processed. This is achieved, at least in part, by recognizing a market event and by creating a time window of a selected duration following that market event. Examples of market events include receiving an order at a new price, detecting a change in the National Best Bid or Offer (referred to as NBBO), detecting that a new price level is established on a different exchange, etc. Several orders received during this window may be treated as having been received effectively at the same time. The orders received in this window are queued for sequential processing using a procedure and/or order parameter(s) other than but not necessarily exclusive of the actual time of receiving the orders. Thus, a meta queue of the orders received within a time window is formed, and none of the orders received during that time window may be prioritized over another order in that window solely on the basis of order arrival time.

Because the orders received during the selected time window are considered to have effectively arrived at the same time, the participants whose orders are actually received only slightly later than orders from high-speed participants, the orders of the non-high-speed participants are not always prioritized behind the orders of the high-speed participants. The length of the time window can be selected based on the estimated time benefit the specialized communication and/or computation technology can provide. The orders received after the time window is closed may be prioritized after the orders in the meta-queue. In this way, participants who do not have access to specialized communication and/or computation technology may not always be at a disadvantage relative to participants who do have such access, while still allowing the participants generally taking an action before the others to have priority over the others.

Accordingly, in one aspect, a method is provided for compensating for communication or computation delays affecting orders received by an electronic trading system. The method includes receiving via a communication interface an order that includes at least an order price and an order timestamp. The method also includes accessing from a memory a bin corresponding to the order price, where the bin includes a priority-parameter-agnostic partition and a priority-parameter-based partition. The priority-parameter-agnostic partition is associated with a partition-formation time and/or a number of elements in the priority-parameter-agnostic partition.

The method further includes recording the order in the priority-parameter-agnostic partition based on at least in part at least one of: (i) an order-related parameter, and (ii) whether a difference between the partition-formation time and the order timestamp is less than or equal to a delay threshold. If it is determined that the order is not to be recorded in the priority-parameter-agnostic partition, the method includes recording the order in the priority-parameter-based partition. The delay threshold may include a sum of an average delay from a price quotation source to a trading station and an average delay from the trading station to the electronic trading system. The delay threshold may range from 300 μs up to 10 ms.

In some embodiments, accessing the bin from the memory includes determining that no bin in the memory corresponds to the order price; creating and associating a new bin with the order price; and designating the order timestamp as the partition-formation time. The priority-parameter-agnostic partition may include a queue, where a place of the order within the queue is based on at least in part, at least one of: the order timestamp, an order size, and a random order place. In some embodiments, the method further includes receiving via the communication interface a contra order, and matching a first portion of the contra order up to a first match size with at least a first portion of an order in a first place in the queue. The first match size may be one of: a lot size, a size of the order in the first place, and a pre-selected percentage of the size of the order in the first place.

In some embodiments, the method further includes matching a second portion of the contra order up to a second match size with at least a first portion of an order in a second place in the queue. The second match size can be one of: the lot size, the size of the order in the second place, and the pre-selected percentage of size of the order in the second place. The method may further include matching a third portion of the contra order up to the first match size with at least a second portion of the order in the first place in the queue. In addition, the method may include matching a fourth portion of the contra order up to the second match size with at least a second portion of the order in the second place in the queue. In some embodiments, the method includes determining that each order the queue is matched in entirety with one or more portions of the contra order, and matching at least a fraction of a remainder of the contra order with at least a portion of a first order in the priority-parameter-based partition.

In some embodiments, the method includes receiving via the communication interface a contra order, and selecting a first order from the priority-parameter-agnostic partition according to a specified selection schedule that includes at least one of a round-robin selection, a random selection, an order-timestamp-based selection, and an order-size-based selection. The method may also include matching a first portion of the contra order up to a first match size with at least a first portion of the selected first order. The first match size can be one of: a lot size and a pre-selected percentage of size of the selected first order. Thus, instead of forming a queue in the priority-parameter-agnostic partition and selecting orders from the queue according to order positions in the queue, one or more orders are selected from the priority-parameter-agnostic partition as needed for matching, based on the specified selection schedule.

In some embodiments, the method further includes selecting a second order from the priority-parameter-agnostic partition according to the specified selection schedule, and matching a second portion of the contra order up to a second match size with at least a first portion of the selected second order. The second match size can be one of: the lot size and the pre-selected percentage of size of the selected second order. The method may also include matching a third portion of the contra order up to the first match size with at least a second portion of the selected first order. In addition, the method may include matching a fourth portion of the contra order up to the second match size with at least a second portion of the selected second order. In some embodiments, the method further includes determining that each order the priority-parameter-agnostic partition is matched in entirety with one or more portions of the contra order, and matching at least a fraction of a remainder of the contra order with at least a portion of a first order in the priority-parameter-based partition.

In some embodiments, the order-related parameter includes a number of orders in the priority-parameter-agnostic partition, and recording the order in the priority-parameter-agnostic partition includes determining that the number of orders in the priority-parameter-agnostic partition is less than a maximum permissible number of orders. The order-related parameter may include order source, and recording the order in the priority-parameter-agnostic partition may be based on, at least in part, whether the order source is designated retail. In some embodiments, the method includes determining via respective sources of each one of a plurality of orders in the priority-parameter-agnostic partition that a single non-retail source is the source of each order in the plurality of orders, and grouping all orders within the plurality of orders into a single order.

In some embodiments, the order includes at least one of a displayed portion and a non-displayed portion. Accessing the bin from the memory may include accessing at least one of a displayed bin associated with the displayed portion of the order, and a non-displayed bin associated with the non-displayed portion of the order. The displayed bin and non-displayed bin each may include a respective priority-parameter-agnostic partition and a respective priority-parameter-based partition.

In another aspect, a system is provided for compensating for communication or computation delays affecting orders received by an electronic trading platform. The system includes a first processor and a first memory in electrical communication with the first processor. The first memory includes instructions that can be executed by a processing unit including the first processor or a second processor, or both. The processing unit may be in electronic communication with a memory module that includes the first memory or a second memory or both.

The instructions in the first memory program the processing unit to: receive via a communication interface an order that includes at least an order price and an order timestamp. The instructions also program the processing unit to access from a memory a bin corresponding to the order price, where the bin includes a priority-parameter-agnostic partition and a priority-parameter-based partition. The priority-parameter-agnostic partition is associated with a partition-formation time and/or a number of elements in the priority-parameter-agnostic partition.

Moreover, the instructions program the processing unit to record the order in the priority-parameter-agnostic partition based on at least in part at least one of: (i) an order-related parameter, and (ii) whether a difference between the partition-formation time and the order timestamp is less than or equal to a delay threshold. The instructions program the processing unit such that if it is determined that the order is not to be recorded in the priority-parameter-agnostic partition, the processing unit is programmed to record the order in the priority-parameter-based partition. In various embodiments, the instructions can program the processing unit to perform one or more of the method steps described above.

In another aspect, an article of manufacture is provided that includes a non-transitory storage medium having stored therein instructions which, when executed by a processing unit program the processing unit, which is in electronic communication with a memory module, to compensate for communication or computation delays affecting orders received by an electronic trading platform.

The instructions program the processing unit to: receive via a communication interface an order that includes at least an order price and an order timestamp. The instructions also program the processing unit to access from a memory a bin corresponding to the order price, where the bin includes a priority-parameter-agnostic partition and a priority-parameter-based partition. The priority-parameter-agnostic partition is associated with a partition-formation time and/or a number of elements in the priority-parameter-agnostic partition.

Moreover, the instructions program the processing unit to record the order in the priority-parameter-agnostic partition based on at least in part at least one of: (i) an order-related parameter, and (ii) whether a difference between the partition-formation time and the order timestamp is less than or equal to a delay threshold. The instructions program the processing unit such that if it is determined that the order is not to be recorded in the priority-parameter-agnostic partition, the processing unit is programmed to record the order in the priority-parameter-based partition. In various embodiments, the instructions can program the processing unit to perform one or more of the method steps described above.

One technical effect of various embodiments of the present invention is that a venue or platform for electronically processing transactions in items can be adapted based on the latest high-speed computation and/or communication technology. Specifically, the length of the time window associated with a meta-queue maintained by the venue can be customized based on the estimated time benefit the specialized communication and/or computation technology can provide. This can automatically partition the received orders into a first group of orders likely submitted at approximately the same time (e.g., within a few microseconds, milliseconds, seconds, etc.), and a second group of orders submitted at a later time, i.e., more than a few microsecond, milliseconds, seconds, etc., after one or more orders in the first group were submitted. This facilitates a classification of orders based on one or more system parameters such as expected computation time, transmission delay, etc. Furthermore, within the two groups different prioritization schemes can be implemented for the transactions to be performed. Another technical effect of various embodiments of the present invention is that the meta-queue implementation allows customizable, sequential processing of a group of transaction orders.

### BRIEF DESCRIPTION OF THE DRAWINGS

Various embodiments of the present invention taught herein are illustrated by way of example, and not by way of limitation, in the figures of the accompanying drawings, in which:

FIG. 1A schematically depicts a venue (also called a platform) for performing transactions according to various embodiments, and a typical environment of the venue;

FIG. 1B schematically depicts an order book according to one embodiment, that is maintained at the platform shown in FIG. 1A; and

FIG. 1C schematically depicts a meta-queue according to one embodiment, created within the order book shown in FIG. 1B.

### DETAILED DESCRIPTION OF THE INVENTION

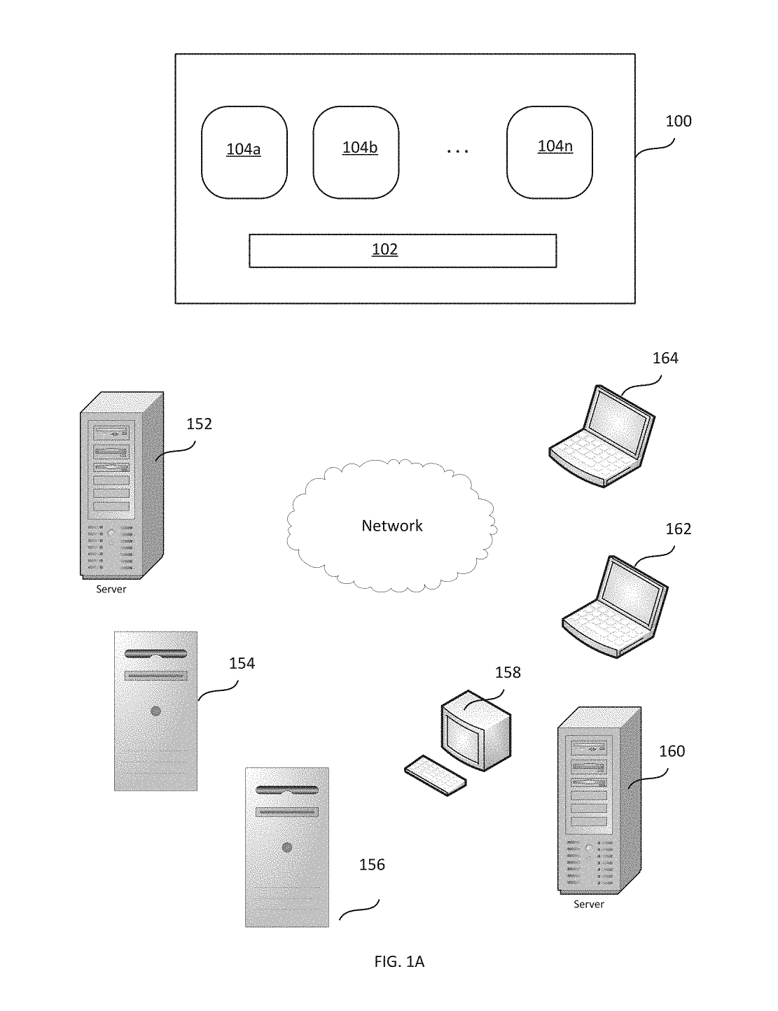

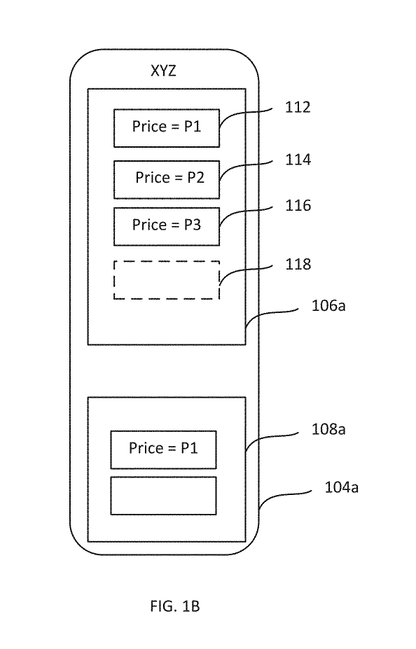

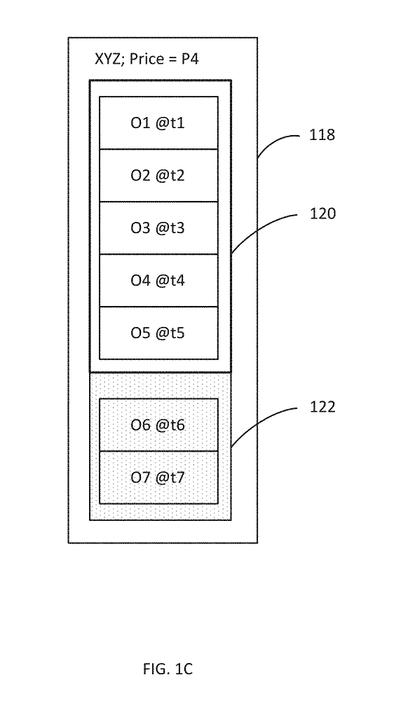

With reference to FIGS. 1A-1C, a platform 100 (also called a venue) allows various participants 152-164 to perform transactions relating to one or more items of interest. The platform includes one or more communication interfaces or ports 102, to communicate with one or more participants. In some embodiments, the item of interest is a security such as a stock or a bond. In other embodiments, the item of interest can be a derivative, such as a stock option, one or more shares of an exchange traded fund (ETF), etc. While the description below generally considers a security as the item of interest, this is only for the sake of convenience. The techniques described herein are applicable to various different types of items of interest and transactions. It should also be understood that seven participants 152-164 are described for illustrative purposes only. In general, there can be as few as two and more than seven, e.g., tens, hundreds, thousands, or even more participants performing transactions relating to one or more items (e.g., tens, hundreds, or thousands of items), of the same or different types.

Typically for a security, at a particular instant of time, the platform 100 has a best price associated with that security. For orders to buy a security, the best price is generally the highest price either at the platform 100 or across several different trading platforms. For buy orders, the highest price across several major or all trading platforms is commonly referred to as National Best Bid (NBB). Similarly, for orders to sell a security, the best price is generally the lowest price either at the platform 100 or across several different trading platforms. For sell orders, the lowest price across several major or all trading platforms is commonly referred to as National Best Offer (NBO). Collectively, the best buy and sell prices across several platforms are typically referred to as NBBO. The best prices associated with a security and/or the NBBO may be stored in a memory module at the platform.

At a trading platform, usually an order book is maintained for each security traded at that platform, such as order books 104a, 104b, etc., up to the order book 104n. Two different order books may be maintained for buy and sell orders, respectively, or, in some implementations different types of orders may be recorded in a single book. Usually, an order book is divided into different price-sections (also called bins) where each price-section/bin corresponds to a particular price.

An order book may also be split into a displayed partition and a non-displayed (also called hidden) partition and, each partition may include one or more price-sections. Orders recorded in the displayed partition can be seen by other participants at the platform, while orders recoded in the non-displayed partition are hidden from other participants. Participants may indicate while submitting an order whether that order or a portion thereof is to be displayed or hidden from others. An order or a portion thereof in either partition can be matched and traded with a contra-order or a portion thereof recorded in a displayed or non-displayed partition. In some cases, the order book is not partitioned as described above, but an order or a portion thereof is designated as displayed and/or an order or a portion thereof is designated as non-displayed. The processing of a displayed order or order portion may be prioritized over the processing of a non-displayed order or order portion. Applicant's co-owned U.S. patent application Ser. No. 15/368,010, entitled “Systems and Methods for Processing Full or Partially Displayed Dynamic Peg Orders in an Electronic Trading System,” filed on Dec. 2, 2016, describes processing of orders having displayed (also called lit) and non-displayed (also called non-lit) portions, and systems for such processing, which is incorporated herein by reference in its entirety.

To illustrate, the order book 104a records Buy orders for security XYZ, and has a displayed partition 106a and a non-displayed partition 108a. The displayed partition 106a includes three prices sections (bins) 112, 114, 116, respectively corresponding to three different prices P₁, P₂, and P₃. The highest of P₁, P₂, and P₃ can be the NBB for the security XYZ, or the NBB can be a different price. It should be understood that three price sections of the displayed partition 106a are illustrative only, and that an order book may include any number of price sections such as 1, 5, 10, 18, etc., price sections. The non-displayed partition 108a may also include any number of price sections such as 1, 4, 9, 20, etc., price sections. The number of price-sections in a non-displayed partition can be the same as the number of price-sections in a displayed partition, or the two numbers can be different. The prices associated with the different price-sections of the non-displayed partition can be the same as or different from the prices associated with the different price-sections of the displayed partition.

Generally one or more orders are recorded within each price section. For example, all of the orders recorded in the price section 112 would be Buy orders for security XYZ at price P₁. These orders may be received from different participants via the communication interface/port 102 at the venue 100, though two or more orders in the section 112 may have been submitted by a single participant. These orders may have been received at different times, and/or they may have different sizes, where an order size is the number of units of the corresponding security. On many conventional platforms, the orders recorded in a particular price-section are sorted by the time of arrival. On some platforms, the orders may be sorted by the order size and, the orders of the same size may be sorted further according to the order arrival time. The orders are generally processed in the sorted order, where orders that arrived only slightly before other orders may be prioritized for processing, as described above.

If an order at a new price (i.e., a price for which the order book does not already include a price-section) is received, a new price-section is created in the order book. The new price can indicate that one or more participants have new information and/or new analysis, based on which those participants have changed their bid or offer price. In some embodiments, receiving an order with a new price is considered a trigger event and a time window of duration δ is created at the time at which the first order with the new price is received. Other examples of trigger events include detecting a change in the NBBO for a particular security, detecting that a new price level is established for a particular security on a different exchange, etc. Referring to FIGS. 1B and 1C, in one example a Buy order O₁ for the security XYZ at the price P₄ is received at time t₁. Therefore, at time t₁ a new price-section/bin 118 corresponding to the price P₄ is created, and a window of duration δ is also created. The trigger event used in this discussion is receiving an order at a new price. It should be understood, however, that this is for the sake of convenience only, and that any other market event, including those described above, can be used to create a window. The value of δ (the duration of the window) can be a few or several microseconds, a few or several milliseconds, or a few seconds. The order O₁ is entered in to the price-section 118.

At a later time t₂, another Buy order O₂, also for the security XYZ at the price P4, is received. If the difference (t₂−t₁) is less than or equal to the length of the time window δ, a meta-queue (also called a time-agnostic partition, where time of arrival is the order priority parameter) 120 is formed within the price-section 118, and both orders O₁ and O₂ are recorded in the meta-queue 120. Subsequently, additional Buy orders O₃, O₄, and O₅ are received at times t₃, t₄, and t₅, respectively, where t₁<t₂<t₃<t₄<t₅, and each of the differences (t₃−t₁), (t₄−t₁), and (t₅−t₁) is also less than or equal to the length of the time window δ. Therefore, the orders O₃, O₄, and O₅ are also recorded in the meta-queue 120. Buy orders O₆ and O₇ are received at times t₆ and t₇, respectively, where both differences (t₆−t₁) and (t₇−t₁) are greater than the length of the time window δ. Therefore, the orders O₆ and O₇ are recorded in the price-section 118, but outside the meta-queue 120, i.e., in a priority-parameter-based partition 122, prioritized behind the meta-queue 120. In this example, the priority parameter is the time of arrival and, as such, the partition 122 may be called a time-based partition.

In this example, referring to FIGS. 1A and 1C, the order O₁ was received from the participant 152 and the orders O₂ and O₄ were received from the participant 160. These two participants are high-speed participants. The order O₃ was received from the participant 158, the order O₅ was received from the participant 162, the order O₆ was received from the participant 156, and the order O₇ was received from the participant 164. The participants 156, 158, 162, 164 are not high-speed participants. It should be understood that this example is illustrative only. In general, a meta-queue may include any number of orders (e.g., 2, 6, 10, 35, 80, or more orders). Similarly, a price-section in which a meta-queue is formed can include any number of orders (e.g., 1, 8, 20, 32, or more orders) outside the meta-queue. One or more participants may submit one order or more than one orders. Depending upon their respective arrival times, one or more of these orders may be included in the meta-queue and/or one or more of these orders may be included in the price-section outside the meta-queue.

In general in processing orders, each order is matched against a contra-order. For example, Buy orders are matched with Sell orders and Sell orders are matched with Buy orders. In the foregoing example, assume that the sizes of the orders O₁ through O₇ are S₁ through S₇, respectively. Two or more orders can have the same size. Suppose the venue 100 already has or receives a contra order (i.e., a Sell order in this example) for XYZ at price P₄ via the communication interface/port 102, and that the size of the contra-order is S_{c}. On a conventional platform that does not implement a meta-queue, the order O₁ has the highest priority based on the arrival times of the orders. Therefore, If (S₁≤S_{C}), the entire order O₁ would be matched against the contra-order, before any of the other orders (i.e., the orders O₂ through O₇ in this example) are processed. If (S₁<S_{C}) and if (S₂≤(S_{C}−S₁)), the entire order O₂ would be matched against the remainder of the contra-order, before any of the other unprocessed orders (i.e., the orders O₃ through O₇ in this example) are processed. If (S₁<Sₑ) and if (S₂>(S_{C}−S₁)), a portion of the order O₂ would be matched against the remainder of the contra-order, which would then be exhausted. The remainder of the order O₂ and the other unprocessed orders would await arrival of one or more additional contra-orders.

The meta-queues do not operate in this conventional manner. Instead, in some embodiments a lot size denoted a is selected where the lot size is generally smaller than the size of a typical order. In the foregoing example, a units of one or more of the orders O₁ through O₅ in the meta-queue 120 are matched with the corresponding units of the contra-order. For instance, if S_{C}=kσ, σ units each of any k of the total number orders in the meta-queue 120 (e.g., three out of five in this example, if k=3), are matched with the corresponding units of the contra-order. The number k can be less than, equal to, or greater than the total number of orders included in a meta-queue (denoted μ). If k>μ, two or more lot sizes of one or more orders in the meta-queue are selected for matching with the contra-order in different processing rounds.

In some cases, the k orders are selected in a random manner. The k orders may be selected according to the order size, time of arrival of the order, whether the order (or a portion thereof) is designated as displayed or non-displayed, or any other order parameter. In this way, the entire order O₁ is not prioritized over the other orders in the meta-queue 120 (i.e., the orders O₂ through O₅), that were received only slightly after the order O₁ was received. In some cases, the sequence in which the orders in a meta-queue are processed is determined once, at random, or based on the order size, time of arrival of the order, whether the order (or a portion thereof) is designated as displayed or non-displayed, or any other order parameter, and that sequence used repeatedly until all orders in the meta-queue are processed entirely. As such, the orders in the meta-queue are processed in a round-robin manner. The sequence can be formed in the ascending order of the values of the selected order parameter(s) or in the descending order of such values.

In some cases, each time a contra-order or a portion thereof can be matched against one or more orders in a meta-queue, up to k orders in the meta-queue are selected in a random manner or according to some order parameter. A different order parameter may be selected for each round, i.e., the same order sequence need not be used in different processing rounds. While the order book 104a includes the displayed partition 106a and the non-displayed partition 108a, in some embodiments, a price-section/bin, a meta-queue therein, and/or a priority-parameter-based partition within the price-section/bin may include orders or order portions that are designated as displayed or non-displayed. In forming an order sequence to be used for selecting orders in different rounds, and/or in selecting an order for processing thereof in a particular round, priority can be given to a displayed order or a displayed portion thereof. Priority can also be given to a non-displayed order or a non-displayed portion of an order.

In some cases, the orders in a meta-queue are matched with a contra order on a pro-rated basis. In other words, the lot size a for all the orders in the meta-queue need not be the same and can be a percentage of the total order size. As discussed above, up to k orders may be selected on the basis of the total order size of the contra order or another order parameter, or at random. In general, for an order Oₚ in a meta-queue, the number of units matched with a contra-order can be σₚ, where σₚ is a fixed or variable percentage of the total order size of the order Oₚ. The percentage values for different orders in a meta-queue can be different and may change across the matching or processing rounds.

When an order is received at the venue 100, the type of the sender of the order can be identified. For orders for transactions in securities, the sender can be a broker or a retail sender. In some cases, the venue 100 determines the sender type for each received order, and the orders received from retail senders are always included in a meta-queue regardless of whether the time window is open or closed. In some cases, within a meta-queue the orders received from the retail participants are prioritized over the orders received from brokers. If orders from two or more retail participants are received, they can be prioritized relative to one another according an order parameter or at random.

In some cases, a broker may split a single order into several small orders, all or many of which may be received at the venue before the window closes. As such, that broker participant may have several orders in the meta-queue, and more than one or even all of these may be processed. In effect, via several small orders, that broker can trade a large number (i.e., a multiple of the lot size a) of units of a particular security. Such a broker can be can be a high-speed participant, or another participant. In order to mitigate or avoid this advantage to a participant, several small orders in a meta-queue that are determined to have been received from a single participant are aggregated into a single aggregate order so that only a units of the aggregate order are processed in each round. In some cases, such aggregation is not performed if the sender is a retail sender.

In general, only after all orders in a meta-queue are completely processed, the remaining orders in the corresponding price-section are processed according to the arrival times of those orders. Thus, in the foregoing example, after the orders O₁ through O₅ have been processed completely, the order O₆ is matched against the next available contra-order. After the order O₆ has been processed completely, the order O₇ is matched against the next available contra-order.

### Examples

### Example 1

In this example, a new price-section (also called a bin B1), and a meta-queue M1 (also called a priority-parameter-agnostic partition) are created when an Order A for a security PQR at a price p is received. Before the meta-queue M1 is closed, two other orders (Orders B and C) are also received for the security PQR at the price p, and are recorded in the meta-queue. In this example, an order sequence “A-B-C” is formed according to the order-arrival time, as shown in the table below, which also shows the order arrival time and the order size. Other orders for the security PQR at the price p may be received after the time window is closed. Such other orders may be included in the price-section/bin B1, but not in the meta-queue M1.

| Order Name | Arrival Timestamp | Order Size |
|---|---|---|
| A | 10:05:21:11867065 | 200 |
| B | 10:05:21:11867098 | 100 |
| C | 10:05:21:11867203 | 200 |

The venue also received a contra order of size 400 for the security PQR at the price p so that the orders A, B, and/or C can be matched with the contra order. In some cases, the contra order can be an already pending, i.e., a resting order. The matching is performed according to a lot size of 100, in the sequence shown in the table below.

| Step | Processing Round | Order:Lot No.:Size |
|---|---|---|
| 1 | 1 | A:1:100 |
| 2 | 1 | B:1:100 |
| 3 | 1 | C:1:100 |
| 4 | 2 | A:2:100 |

In the first round only 100 units of the Order A are matched with the contra order, and then 100 units each of the Orders B and C are matched with 200 additional units of the contra order. At the end of the first round, 100 units of the contra order are still outstanding. As such, 100 units of the first order in the sequence in the meta-queue (i.e., the Order A) are matched with the contra order in a second round. At this time, 100 units of the Order C have not been processed. These units can be matched with another contra-order when such a contra-order becomes available at the venue. Thus, in Example 1 the meta-queue is implemented according to a round-robin allocation scheme, where the initial ordering is determined by the arrival time.

### Example 2A

In this example, a new price-section/bin B2, and a meta-queue M2 (a priority-parameter-agnostic partition) are created when an Order A for a security JKL at a price q is received. Before the meta-queue M2 is closed, three other orders (Orders B, C, and D) are also received for the security JKL at the price q, and are recorded in the meta-queue. The table below shows the order arrival time and the order size for each order, and it can be observed that the Order A was received first, followed by Order B, followed by Order C, followed by Order D. Other orders for the security JKL at the price q may be received after the time window is closed, and such other orders may be included in the price-section/bin B2, but not in the meta-queue M2. In this example, an order sequence “C-A-D-B” is formed in the meta-queue M2 by selecting the orders in the meta-queue at random.

| Order Name | Arrival Timestamp | Order Size |
|---|---|---|
| C | 02:16:29:00145 | 50 |
| A | 02:16:29:00120 | 100 |
| D | 02:16:29:00209 | 200 |
| B | 02:16:29:00143 | 100 |

The venue also received (or may already have) a contra order of size 400 for the security JKL at the price q, so that the orders A, B, C, and/or D can be matched with the contra order. The matching is performed according to a lot size of 100, in the sequence shown in the table below.

| Step | Processing Round | Order:Lot No.:Size |
|---|---|---|
| 1 | 1 | C:1:50 |
| 2 | 1 | A:1:100 |
| 3 | 1 | D:1:100 |
| 4 | 1 | B:1:100 |
| 5 | 2 | D:2:50 |

In the first round, all 50 units of the Order C are matched with the contra order, and then 100 units each of the Orders A, D, and B are matched with 300 additional units of the contra order. At the end of the first round, 50 units of the contra order are still outstanding. As such, 50 units of the first outstanding order in the sequence in the meta-queue (i.e., the Order D) are matched with the contra order in a second round. At this time, 50 units of the Order D have still not been processed. These units can be matched with another contra-order when such a contra-order becomes available at the venue. Thus, in Example 2A the meta-queue is implemented according to a round-robin allocation scheme, where the initial ordering is determined in a random manner.

### Example 2B

In this example, the new price-section/bin B2, and the meta-queue M2 are created as described above in Example 2A. Instead of a round-robin matching, the orders in the meta-queue M2 are matched on a pro-rated basis, as shown in the table below.

| Step | Processing Round | Order:Lot No.:Size |
|---|---|---|
| 1 | 1 | C:1:45 |
| 2 | 1 | A:1:85 |
| 3 | 1 | D:1:185 |
| 4 | 1 | B:1:85 |

In the first round, 45 of the total 50 units of the Order C are matched with the contra order, and then 85 units each of the Orders A and B, and 185 units of Order D are matched with the remaining 355 units of the contra order. These numbers are based approximately on the ratio of the size of a respective order in the meta-queue to the total number of units in the meta-queue. The rounding off can be accomplished in any manner, such as rounding up or down to the nearest integer, the nearest multiple of 5, 10, or another number, etc. In some cases, instead of leaving a small number of units (such as 5 units of Order C) unmatched, the entire Order C may be matched. In this example, at the end of the first round, 5 units of Order C, 15 units each of Orders A and B, and 15 units of Order D are still unmatched. These units can be matched with another contra-order when such a contra-order becomes available at the venue. Thus, in Example 2B, the meta-queue is implemented according to a pro-rated allocation scheme, while the initial ordering is still determined in a random manner.

### Example 2C

In this example also, the new price-section/bin B2, and the meta-queue M2 are created as described above in Example 2A. Instead of round-robin matching or matching on pro-rated basis, the orders in the meta-queue M2 are matched simply only the basis of their location in the meta-queue, as shown in the table below.

| Step | Processing Round | Order:Lot No.:Size |
|---|---|---|
| 1 | 1 | C:1:50 |
| 2 | 1 | A:1:100 |
| 3 | 1 | D:1:200 |
| 4 | 1 | B:1:50 |

In the first round, all of the total 50 units of the Order C are matched with the contra order. Then all 100 units of the Order A and all 200 units of Order D are matched with the corresponding units of the contra order. The remaining 50 units of the contra order are matched with 50 units of Order B and, at 50 additional units of Order B would remain unmatched. These units can be matched with another contra-order when such a contra-order becomes available at the venue. Thus, in Example 2C, the meta-queue is implemented according to a simple priority scheme, while the initial ordering and the priority is determined in a random manner. The initial ordering and/or the priority can be based on any other order/request parameter such as time of arrival, order size, etc.

### Example 3A

In this example, a new price-section/bin B3, and a meta-queue M3A (a priority-parameter-agnostic partition) are created when an Order C for a security LMN at a price r is received. Before the meta-queue M3A is closed, four other orders (Orders B, A, D, and E) are also received for the security LMN at the price r, and are recorded in the meta-queue. The table below shows the order arrival time and the order size for each order, and it can be observed that the Order C was received first, followed by Order B, followed by Order A, followed by Order D, followed by Order E. Other orders for the security LMN at the price r may be received after the time window is closed, and such other orders may be included in the price-section/bin B3, but not in the meta-queue M3A. In this example, an order sequence “A-B-D-C-E” is formed in the meta-queue M3A by selecting the orders in the meta-queue in increasing order of their respective sizes. In this example, the ordering of the requests/orders in the meta-queue is according to the increasing order size, i.e., in the meta-queue an order of a smaller size is prioritized over an order of a larger size. In some embodiments, an order of a larger size may be prioritized over an order of a smaller size. For example, the sequence of orders in the meta-queue can be E-C-D-B-A, in some embodiments.

| Order Name | Arrival Timestamp | Order Size |
|---|---|---|
| A | 10:05:21:74202155 | 50 |
| B | 10:05:21:74202116 | 100 |
| D | 10:05:21:74202208 | 100 |
| C | 10:05:21:74202104 | 200 |
| E | 10:05:21:74202217 | 400 |

The venue also received (or may already have) a contra order of size 1,000 for the security LMN at the price r so that the orders A, B, C, D, and/or E can be matched with the contra order. The matching is performed according to a lot size of 100, in the sequence shown in the table below.

| Step | Processing Round | Order:Lot No.:Size |
|---|---|---|
| 1 | 1 | A:1:50 |
| 2 | 1 | B:1:100 |
| 3 | 1 | D:1:100 |
| 4 | 1 | C:1:100 |
| 5 | 1 | E:1:100 |
| 6 | 2 | C:2:100 |
| 7 | 2 | E:2:300 |

In the first round, all 50 units of the Order A are matched with the contra order, and then 100 units each of the Orders B, C, D, and E are matched with 400 additional units of the contra order. At the end of the first round, 550 units of the contra order, 100 units of Order C, and 300 units of Order E are still outstanding. In a second round, 100 units of the first outstanding order in the sequence in the meta-queue (i.e., the Order C) are matched with the contra order. As a portion of only one order (i.e., the Order E) now remains in the meta-queue M3A, all of the remaining units of the Order E are matched with the contra order in the second round. Had there been portions of two or more orders remaining in the meta-queue, up to 100 units of each of those orders would have been matched with the contra-order in the second round. Additional processing rounds may be executed, as necessary.

At the end of the second round, all orders in the meta-queue M3A have been processed completely, but 150 units of the contra order have still not been processed. These units can be matched with one or more orders in the price-section/bin B3 that were not included in the meta-queue M3A. This matching may be done according to the time of arrival of those orders and without dividing those orders according to the lot size. Thus, in Example 3A the meta-queue is implemented according to a round robin allocation scheme, and the initial ordering is determined according to increasing magnitude of the order size.

### Example 3B

In this example also, the new price-section/bin B3 is created as described above in Example 3A. A meta-queue M3B is formed based on the order size, with a larger order taking priority over a relatively smaller order. As such the order sequence in the meta-queue M3B is E-C-D-B-A. In the meta-queue M3B the orders are matched simply only the basis of their location in the meta-queue, as shown in the table below.

| Step | Processing Round | Order:Lot No.:Size |
|---|---|---|
| 1 | 1 | E:1:400 |
| 2 | 1 | C:1:200 |
| 3 | 1 | D:1:100 |
| 4 | 1 | B:1:100 |
| 5 | 1 | A:1:50 |

At the end of the processing round, all orders in the meta-queue M3B have been processed completely, but 150 units of the contra order have still not been processed. These units can be matched with one or more orders in the price-section/bin B3 that were not included in the meta-queue M3B. This matching may be done according to the time of arrival of those orders, size of those orders, etc. Thus, in Example 3B the meta-queue is implemented according to a simple size-based allocation scheme, and the initial ordering is determined according to decreasing magnitude of the order size.

In various embodiments, the length of the time window δ may be selected based on the estimated time benefit a specialized communication and/or computation system can provide. For example, the value of δ can be the difference between the transmission latency of the fastest communication network and the transmission latency of a typical, generally available communication network, where such difference is several microseconds (e.g., 100 μs, 200 μs, 350 μs, 500 μs, etc.). The transmission latency can include the average propagation delay from an information source to a participant. The value of δ may additionally or in the alternative include the difference between the transmission latency of a transmission received from a participant located close to the venue at which a meta-queue is created and the transmission latency of a transmission received from a participant located at a greater distance from the venue. The value of δ can also include a performance lag between a high-speed computer particularly adapted to analyze security-transactions data and a generally available computer processing such data. As such, in different embodiments, the value of δ can be a few, tens, or hundreds of microseconds, a few, tens, or hundreds of milliseconds, a few or tens of seconds, etc.

In some embodiments, the value of δ is not directly based on system parameters such as differences in communication and/or computation delays, but may be based on empirical analysis of the observed differences between the time of arrival of an order sent by a high-speed participant and an order sent by a non-high-speed participant. Here again, the value of δ can be a few, tens, or hundreds of microseconds, a few, tens, or hundreds of milliseconds, a few or tens of seconds, etc. In some cases, instead of closing a meta-queue after a selected time has elapsed, the meta-queue may be closed after a preselected number of orders (e.g., 5, 10, 30, etc. orders) are included in the meta-queue. In some cases, the meta-queue may be closed based on both a time window and the number of orders included in the meta-queue.

While the overall order queue within which the meta-queue 120 (FIG. 1C) is formed is a queue based on the time of arrival, (i.e., orders in general are prioritized according to the time of arrival) this is for illustrative purposes only. In general, a queue and the corresponding meta-queue can be formed and operated according to any request/order parameter such as order size, sender type, frequency of orders received from different senders, etc. In other words, the prioritization of the processing of requests and the selection of one or more requests for inclusion into a meta-queue can be based on any order/request parameter, such as those described above.

Also, while the meta-queue 120 (FIG. 1C) is described for the processing of securities orders, a meta-queue in general is a specialized data structure that can be used for efficient processing of many different kinds of events and responses to such events. For example, in a distributed computing environment, a node may experience momentary failure and may then recover. Upon recovery, the node may request up-to-date data, which the node may receive from several other nodes. Instead of using only the first received data, the node can implement a meta-queue where data sets received from several other nodes, where such data sets are received within a selected time window after sending the data request are included in the meta-queue. The recovered node may then select from all of those data sets, that were received only slightly after one another, a particular data set based on one or more suitable criteria such as the data size, a data characteristic, etc.

In a database system, several processors may nearly simultaneously (e.g., within a few microseconds, a few milliseconds, a few seconds, a few minutes, etc.) choose to update a particular data entry. Instead of allowing only the processor from which an update request was received first, a meta-queue of such requests can be formed and a processor may be selected according to one or more system parameters.

It is clear that there are many ways to configure the device and/or system components, interfaces, communication links, and methods described herein. The disclosed methods, devices, and systems can be deployed on convenient processor platforms, including network servers, personal and portable computers, and/or other processing platforms. Other platforms can be contemplated as processing capabilities improve, including personal digital assistants, computerized watches, cellular phones and/or other portable devices. The disclosed methods and systems can be integrated with known network management systems and methods. The disclosed methods and systems can operate as an SNMP agent, and can be configured with the IP address of a remote machine running a conformant management platform. Therefore, the scope of the disclosed methods and systems are not limited by the examples given herein, but can include the full scope of the claims and their legal equivalents.

The methods, devices, and systems described herein are not limited to a particular hardware or software configuration, and may find applicability in many computing or processing environments. The methods, devices, and systems can be implemented in hardware or software, or a combination of hardware and software. The methods, devices, and systems can be implemented in one or more computer programs, where a computer program can be understood to include one or more processor executable instructions. The computer program(s) can execute on one or more programmable processing elements or machines, and can be stored on one or more storage medium readable by the processor (including volatile and non-volatile memory and/or storage elements), one or more input devices, and/or one or more output devices. The processing elements/machines thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processing element as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) and/or processing elements can thus be embedded in one or more devices that can be operated independently or together in a networked environment, where the network can include, for example, a Local Area Network (LAN), wide area network (WAN), and/or can include an intranet and/or the Internet and/or another network. The network(s) can be wired or wireless or a combination thereof and can use one or more communication protocols to facilitate communication between the different processors/processing elements. The processors can be configured for distributed processing and can utilize, in some embodiments, a client-server model as needed. Accordingly, the methods, devices, and systems can utilize multiple processors and/or processor devices, and the processor/processing element instructions can be divided amongst such single or multiple processor/devices/processing elements.

The device(s) or computer systems that integrate with the processor(s)/processing element(s) can include, for example, a personal computer(s), workstation (e.g., Dell, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor”, or “a processing element,” “the processor,” and “the processing element” can be understood to include one or more microprocessors that can communicate in a stand-alone and/or a distributed environment(s), and can thus can be configured to communicate via wired or wireless communication with other processors, where such one or more processor can be configured to operate on one or more processor/processing elements-controlled devices that can be similar or different devices. Use of such “microprocessor,” “processor,” or “processing element” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communication protocols, and unless otherwise specified, can be arranged to include a combination of external and internal memory devices, where such memory can be contiguous and/or partitioned based on the application. For example, the memory can be a flash drive, a computer disc, CD/DVD, distributed memory, etc. References to structures include links, queues, graphs, trees, and such structures are provided for illustration and not limitation. References herein to instructions or executable instructions, in accordance with the above, can be understood to include programmable hardware.

Although the methods and systems have been described relative to specific embodiments thereof, they are not so limited. As such, many modifications and variations may become apparent in light of the above teachings. Many additional changes in the details, materials, and arrangement of parts, herein described and illustrated, can be made by those skilled in the art. Accordingly, it will be understood that the methods, devices, and systems provided herein are not to be limited to the embodiments disclosed herein, can include practices otherwise than specifically described, and are to be interpreted as broadly as allowed under the law.

Accordingly, we claim:

1. A method for compensating for communication or computation delays affecting orders received by an electronic trading system, the method comprising:
receiving via a communication interface an order comprising an order price and an order timestamp;
accessing from a memory a bin corresponding to the order price, the bin comprising a priority-parameter-agnostic partition and a priority-parameter-based partition, the priority-parameter-agnostic partition being associated with a partition-formation time;
recording the order in the priority-parameter-agnostic partition based on at least in part at least one of: (i) an order-related parameter, and (ii) whether a difference between the partition-formation time and the order timestamp is less than or equal to a delay threshold;
otherwise, recording the order in the priority-parameter-based partition.

2. The method of claim 1, wherein the delay threshold comprises a sum of an average delay from a price quotation source to a trading station and an average delay from the trading station to the electronic trading system.

3. The method of claim 1, wherein the delay threshold ranges from 300 μs up to 10 ms.

4. The method of claim 1, wherein accessing the bin from the memory comprises:
determining that no bin in the memory corresponds to the order price;
creating and associating a new bin with the order price; and
designating the order timestamp as the partition-formation time.

5. The method of claim 1, wherein:
the priority-parameter-agnostic partition comprises a queue, a place of the order within the queue being based on at least one of: the order timestamp, an order size, and a random order place.

6. The method of claim 5, further comprising:
receiving via the communication interface a contra order; and
matching a first portion of the contra order up to a first match size with at least a first portion of an order in a first place in the queue, the first match size being one of a lot size, a size of the order in the first place, and a pre-selected percentage of the size of the order in the first place.

7. The method of claim 6, further comprising:
matching a second portion of the contra order up to a second match size with at least a first portion of an order in a second place in the queue, the second match size being one of the lot size, the size of the order in the second place, and the pre-selected percentage of size of the order in the second place.

8. The method of claim 7, further comprising:
matching a third portion of the contra order up to the first match size with at least a second portion of the order in the first place in the queue.

9. The method of claim 8, further comprising:
matching a fourth portion of the contra order up to the second match size with at least a second portion of the order in the second place in the queue.

10. The method of claim 6, further comprising:
determining that each order the queue is matched in entirety with one or more portions of the contra order; and
matching at least a fraction of a remainder of the contra order with at least a portion of a first order in the priority-parameter-based partition.

11. The method of claim 1, further comprising:
receiving via the communication interface a contra order;
selecting a first order from the priority-parameter-agnostic partition according to a specified selection schedule comprising at least one of a round-robin selection, a random selection, an order-timestamp-based selection, and an order-size-based selection; and
matching a first portion of the contra order up to a first match size with at least a first portion of the selected first order, the first match size being one of a lot size and a pre-selected percentage of size of the selected first order.

12. The method of claim 11, further comprising:
selecting a second order from the priority-parameter-agnostic partition according to the specified selection schedule; and
matching a second portion of the contra order up to a second match size with at least a first portion of the selected second order, the second match size being one of the lot size and the pre-selected percentage of size of the selected second order.

13. The method of claim 12, further comprising:
matching a third portion of the contra order up to the first match size with at least a second portion of the selected first order.

14. The method of claim 13, further comprising:
matching a fourth portion of the contra order up to the second match size with at least a second portion of the selected second order.

15. The method of claim 11, further comprising:
determining that each order the priority-parameter-agnostic partition is matched in entirety with one or more portions of the contra order; and
matching at least a fraction of a remainder of the contra order with at least a portion of a first order in the priority-parameter-based partition.

16. The method of claim 1, wherein:
the order-related parameter comprises a number of orders in the priority-parameter-agnostic partition; and
recording the order in the priority-parameter-agnostic partition comprises determining that the number of orders in the priority-parameter-agnostic partition is less than a maximum permissible number of orders.

17. The method of claim 1, wherein:
the order-related parameter comprises order source; and
recording the order in the priority-parameter-agnostic partition is based on, at least in part, whether the order source is designated retail.

18. The method of claim 1, further comprising:
determining via respective sources of each one of a plurality of orders in the priority-parameter-agnostic partition that a single non-retail source is the source of each order in the plurality of orders; and
grouping all orders within the plurality of orders into a single order.

19. The method of claim 1, wherein:
the order comprises at least one of a displayed portion and a non-displayed portion; and
accessing the bin from the memory comprises accessing at least one of a displayed bin associated with the displayed portion of the order, and a non-displayed bin associated with the non-displayed portion of the order, the displayed bin and non-displayed bin each having a respective priority-parameter-agnostic partition and a respective priority-parameter-based partition.

20. A system for compensating for communication or computation delays affecting orders received by an electronic trading platform, the system comprising:
a first processor; and
a first memory in electrical communication with the first processor, the first memory comprising instructions which, when executed by a processing unit comprising at least one of the first processor and a second processor, and in electronic communication with a memory module comprising at least one of the first memory and a second memory, program the processing unit to:
receive via a communication interface an order comprising an order price and an order timestamp;
access from a memory a bin corresponding to the order price, the bin comprising a priority-parameter-agnostic partition and a priority-parameter-based partition, the priority-parameter-agnostic partition being associated with a partition-formation time;
record the order in the priority-parameter-agnostic partition based on at least in part at least one of: (i) an order-related parameter, and (ii) whether a difference between the partition-formation time and the order timestamp is less than or equal to a delay threshold;
otherwise, record the order in the priority-parameter-based partition.

21. The system of claim 20, wherein the delay threshold comprises a sum of an average delay from a price quotation source to a trading station and an average delay from the trading station to the electronic trading system.

22. The system of claim 20, wherein the delay threshold ranges from 300 μs up to 10 ms.

23. The system of claim 20, wherein to access the bin from the memory the instructions program the processing unit to:
determine that no bin in the memory corresponds to the order price;
create and associating a new bin with the order price; and
designate the order timestamp as the partition-formation time.

24. The system of claim 20, wherein:
the priority-parameter-agnostic partition comprises a queue, a place of the order within the queue being based on at least one of: the order timestamp, an order size, and a random order place.

25. The system of claim 24, wherein the instructions further program the processing unit to:
receive via the communication interface a contra order; and
match a first portion of the contra order up to a first match size with at least a first portion of an order in a first place in the queue, the first match size being one of a lot size, a size of the order in the first place, and a pre-selected percentage of the size of the order in the first place.

26. The system of claim 25, wherein the instructions further program the processing unit to:
match a second portion of the contra order up to a second match size with at least a first portion of an order in a second place in the queue, the second match size being one of the lot size, the size of the order in the second place, and the pre-selected percentage of size of the order in the second place.

27. The system of claim 26, wherein the instructions further program the processing unit to:
match a third portion of the contra order up to the first match size with at least a second portion of the order in the first place in the queue.

28. The system of claim 27, wherein the instructions further program the processing unit to:
match a fourth portion of the contra order up to the second match size with at least a second portion of the order in the second place in the queue.

29. The system of claim 25, wherein the instructions further program the processing unit to:
determine that each order the queue is matched in entirety with one or more portions of the contra order; and
match at least a fraction of a remainder of the contra order with at least a portion of a first order in the priority-parameter-based partition.

30. The system of claim 20, wherein the instructions further program the processing unit to:
receive via the communication interface a contra order;
select a first order from the priority-parameter-agnostic partition according to a specified selection schedule comprising at least one of a round-robin selection, a random selection, an order-timestamp-based selection, and an order-size-based selection; and
match a first portion of the contra order up to a first match size with at least a first portion of the selected first order, the first match size being one of a lot size and a pre-selected percentage of size of the selected first order.

31. The system of claim 30, wherein the instructions further program the processing unit to:
select a second order from the priority-parameter-agnostic partition according to the specified selection schedule; and
match a second portion of the contra order up to a second match size with at least a first portion of the selected second order, the second match size being one of the lot size and the pre-selected percentage of size of the selected second order.

32. The system of claim 31, wherein the instructions further program the processing unit to:
match a third portion of the contra order up to the first match size with at least a second portion of the selected first order.

33. The system of claim 32, wherein the instructions further program the processing unit to:
match a fourth portion of the contra order up to the second match size with at least a second portion of the selected second order.

34. The system of claim 30, wherein the instructions further program the processing unit to:
determine that each order the priority-parameter-agnostic partition is matched in entirety with one or more portions of the contra order; and
match at least a fraction of a remainder of the contra order with at least a portion of a first order in the priority-parameter-based partition.

35. The system of claim 20, wherein:
the order-related parameter comprises a number of orders in the priority-parameter-agnostic partition; and
to record the order in the priority-parameter-agnostic partition the instructions program the processing unit to determine that the number of orders in the priority-parameter-agnostic partition is less than a maximum permissible number of orders.

36. The system of claim 20, wherein:
the order-related parameter comprises order source; and
the instructions program the processing unit to record the order in the priority-parameter-agnostic partition based on, at least in part, whether the order source is designated retail.

37. The system of claim 20, wherein the instructions further program the processing unit to:
determine via respective sources of each one of a plurality of orders in the priority-parameter-agnostic partition that a single non-retail source is the source of each order in the plurality of orders; and
group all orders within the plurality of orders into a single order.

38. The system of claim 20, wherein:
the order comprises at least one of a displayed portion and a non-displayed portion; and
to access the bin from the memory, the instructions program the processing unit to access at least one of a displayed bin associated with the displayed portion of the order, and a non-displayed bin associated with the non-displayed portion of the order, the displayed bin and non-displayed bin each having a respective priority-parameter-agnostic partition and a respective priority-parameter-based partition.
